(19) United States
(12) Patent Application Publication
(10) Pub. No.: US 2012/0303602 A1
(43) Pub. Date: Nov. 29, 2012

(54) UNIVERSAL LANGUAGE KIT FOR SEARCH ENGINES

(75) Inventors: David Neil Roberts, Leander, TX (US); Jeff Stone, Lago Vista, TX (US)

(73) Assignee: THE DUN & BRADSTREET CORPORATION, Short Hills, NJ (US)

(21) Appl. No.: 13/365,656

(22) Filed: Feb. 3, 2012

Related U.S. Application Data
(60) Provisional application No. 61/439,771, filed on Feb. 4, 2011.

(51) Int. Cl. G06F 17/30

(52) U.S. Cl. 707/706; 707/E17.108

(57) ABSTRACT

The present disclosure provides for a universal language converter for search engines. In this regard there is proved a method that includes (a) receiving application criteria from an application, (b) converting the application criteria into a search expression that is compatible with a search engine, and (c) transmitting the search expression to the search engine. There is also provided a system that employs the method, and a storage medium that contains a program that controls a processor to perform the method.

### CROSS-REFERENCED APPLICATION

This application claims priority to U.S. Provisional Application No. 61/439,771, filed on Feb. 4, 2011, which is incorporated herein by reference in its entirety.

### BACKGROUND

1. Field of the Invention

The present disclosure relates to a universal language converter. In particular, the present disclosure provides a system and method to provide a universal language kit that interfaces with different programming languages to access different data retrieval systems, e.g., search engines.

2. Description of the Related Art

A conventional application that interfaces with an information retrieval system or search engine requires that search criteria and resultant return data relating to a search be formatted according to a search engine-specific program language. For example, common search engines such as Lucene, Solr, Sphinx and FAST each require that search criteria and resultant return data of every search query be programmed in accordance with the search engine specific language. Programming refers to syntax and formatting of the search criteria and the return data. A system architecture can provide for a platform that hosts multiple applications. Each of the multiple applications, in turn, may interface with a search engine further requiring programming according to the search engine. If, at the platform level, there is a change from a first search engine to a different search engine, each application will require a laborious task of re-programming every application search engine interface to a different search engine format.

Due to these deficiencies, there is a need for a universal language kit that interfaces with a search engine and an application and further insulates the application from interacting with the search engine.

### SUMMARY

The present disclosure provides for a universal language converter for search engines. In this regard there is proved a method that includes (a) receiving application criteria from an application, (b) converting the application criteria into a search expression that is compatible with a search engine, and (c) transmitting the search expression to the search engine. There is also provided a system that employs the method, and a storage medium that contains a program that controls a processor to perform the method.

The present invention provides, in one embodiment, a method of interfacing with a search engine requiring a programming language and parameters. The method comprises receiving application criteria from an application by a universal template; creating a search-example in universal search criteria by the universal template from the application criteria; transmitting the universal search criteria to a criteria aggregator; combining the universal search criteria by the criteria aggregator to create a base search expression; transmitting the base search expression to a native connector; processing the base search expression by the native connector into a finished search expression incorporating the parameters required by the search engine; and transmitting the finished search expression to the search engine.

The present invention also provides, in another embodiment, a system for interfacing with a search engine requiring a programming language and parameters. The system comprises an application that generates application criteria for the search engine; a universal template that creates a search-example in universal search criteria from the application criteria; a criteria aggregator that receives and combines the universal search criteria to create a base search expression; a native connector that receives and processes the base search expression into a finished search expression incorporating the parameters required by the search engine; and a search controller that transmits the finished search expression to the search engine.

A storage medium comprising instructions for an interface for a search engine, which instructions are readable by a processor and cause the processor to receive application criteria from an application by a universal template; create a search-example in universal search criteria by the universal template from the application criteria; transmit the universal search criteria to a criteria aggregator; combine the universal search criteria by the criteria aggregator to create a base search expression; transmit the base search expression to a native connector; and process the base search expression by the native connector into a finished search expression incorporating parameters required by the search engine.

The universal language kit provides an interface to a search engine according to the method and system described above and insulates an application from requiring search engine specific programming.

In a particular embodiment, the universal language kit utilizes a common design pattern called a Data Access Object (DAO) and interfaces with a Fast search engine that utilizes Fast Query Language (FQL). The Fast search engine requires an index profile similar to how a database needs a data definition language to describe how a table is setup. The index profile is first analyzed to determine the particular search criteria required, e.g., classes and methods.

### BRIEF DESCRIPTION OF THE DRAWINGS

FIG. 1 is a block diagram of a system that includes a universal language kit for interfacing with search engine.

FIG. 2 is a flow diagram of a process in which the universal language kit of FIG. 1 is serving as an interface between an application and a search engine.

FIG. 3 is a block diagram of a system that includes a server that hosts the universal language kit of FIG. 1.

FIG. 4 is a block diagram of a computer implementation of the server of FIG. 3.

### DESCRIPTION OF THE PREFERRED EMBODIMENT

A universal language kit provides an interface to a search engine and insulates an application from requiring search engine specific programming.

In a particular embodiment, the universal language kit utilizes a common design pattern called a Data Access Object (DAO) and interfaces with a Fast search engine that utilizes Fast Query Language (FQL). The Fast search engine requires an index profile similar to how a database needs a data definition language to describe how a table is setup. The index profile is first analyzed to determine the particular search criteria required, e.g., classes and methods.

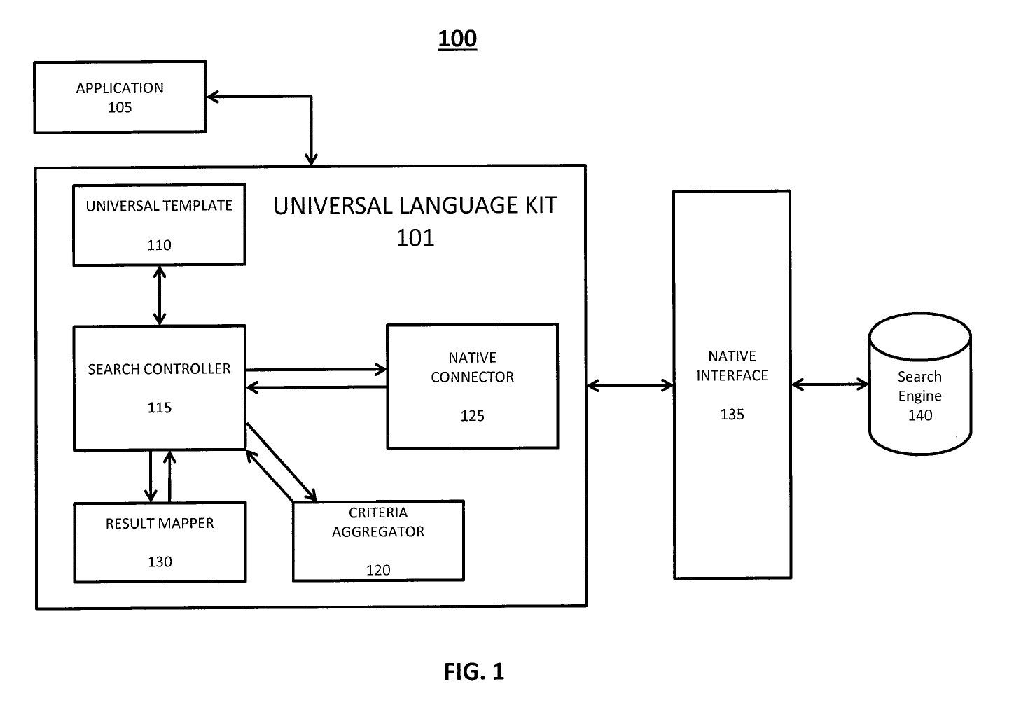

FIG. 1 is a block diagram of a system 100 that includes a universal language kit 101 for interfacing with search engine, e.g., search engine 140. System 100 also includes an application 105, and a native interface 135.

Universal language kit 101 is an interface between application 105 and search engine 140. In general, universal language kit 101 (a) receives a query from application 105, and converts the query into a format that can be utilized by search engine 140, and (b) receives a result from search engine 140, and formats the result for use by application 105. Thus, universal language kit 101 relieves application 105 of the responsibility of having to accommodate requirements of search engine 140. Moreover, although universal language kit 101 is shown as interfacing with only one search engine, i.e., search engine 140, in practice, universal language kit 101 could interface with many search engines. As such, universal language kit 101 relieves application 105 of the responsibility of having to accommodate requirements of the many search engines. Additionally, although universal language kit 101 is shown as interfacing with only one application, i.e., application 105, in practice, universal language kit 101 could interface with many applications. That is, universal language kit 101 could be invoked from one of the many applications, to interface with one of the many search engines.

Universal language kit 101 includes a universal template 110, a search controller 115, a result mapper 130, a criteria aggregator 120, and a native connector 125.

Search controller 115 coordinates communication of data, i.e., transmitting and receiving data, amongst universal template 110, criteria aggregator 120, native connector 125 and result mapper 130.

Native interface 135 may be a separate component, as shown in FIG. 1, or a part of universal language kit 101.

Application 105 is a web-based application that a user accesses via a web page, e.g., via the Internet. Application 105 is hosted by a server and receives input criteria from the webpage via a Hyper-Text Transfer Protocol (HTTP request. Application 105 generates application criteria in an application language, e.g., one application criterion may be square feet of a building, e.g., “3000”, and another application criterion may be a city, e.g., “Austin”. It is to be understood the number of criteria depends on the web-based application. That is, a web-based application may generate a single criterion, or, alternatively, the web-based application may generate a large number of criteria. For example, application 105 may generate two application criteria as follows:

Int sqft = Integer.valueOf(httpRequestObject.getParameter(“sqfootage”))
String city = httpRequestObject.getParameter(“city”)

In the above example, the HTTP request “sqfootage” is assigned to the input criteria “3000” and the HTTP request “city” is assigned to the input criteria “Austin”. Moreover, application criterion Int sqft is assigned to the HTTP request “sqfootage” and application criterion String city is assigned to the HTTP request “city”. In this fashion, application criteria are generated.

In addition, application 105 generates additional information such as parameters. Parameters represent other data typically required by a particular search engine. For example, search engine 140 may be a Fast search engine, i.e., a search engine using the Fast Query Language. The Fast search engine requires the parameters to perform a search.

The parameters are used to further refine or enhance the results to search engine 140. Typically, the parameters are not factored into a search query, but, rather, the parameters effect how a search result, e.g., documents returned from a search, are represented. The parameters may include, but are not limited to: a result view, a maximum number of search results or hits, an offset and a navigator.

The result view represents the fields that are returned in the result. The result view represents a field or fields to be searched and returned in a search result. A principle of searching via a search engine is a requirement to specify a field or fields. That is, search engines typically organize data according to a field or fields. For example, a field may be a company name, a city address or a size in square footage of a company. In order for a search engine to process the finished search expression, the field or fields of the finished search expression must be specified.

The hits and offset define a result page with the number of results per page. The hits are defined as the maximum number of matches that a search can generate, or return. Additionally, the offset is an index marker that identifies from where the returned search should start. The hits and offset are used together to allow the search result to be stepped through on a page by page basis.

The navigator is defined as classifications of the result, and the navigator provides information about a search result. For example, a State navigator, when searching for square footage of a company over 3000, will deliver information regarding how many companies within the search result are in a State, i.e., Texas.

In universal language kit 101, the parameters from application 105 are converted into universal parameters. For example:

Navigators
SearchExample searchExample = new SearchExample( );
searchExample.setSearchView(“hoovers”);
searchExample.setHits(20);
List<String> navigators = new ArrayList<String>( );
navigators.add(SearchExample.NAVIGATOR_COUNTRY);
searchExample.setNavigators(navigators);
searchExample.createCriteria( ).andSquareFootageGreaterThan(1000L);
DefaultSearchResult results =

searchDAO.searchForDefaultResultViewDocuments(searchExample);

//get the desired modifier
String fieldName = results.getNavigatorsList( ).get(0).getFieldName( );
IModifier modifier = (IModifier)(results.getNavigatorsList( ).get(0).modifiers( ).next( ));
String value = modifier.getValue( );
List<String> modifiers = new ArrayList<String>( );
modifiers.add(fieldName + “:” + value);
searchExample.andModifiers(modifiers);
DefaultSearchResult rs ==

searchDAO.searchForDefaultResultViewDocuments(searchExample);

Sorting
SearchExample searchExample = new SearchExample( );
List<FastSortOrderColumnEnum> fastSortColumns = new

ArrayList<FastSortOrderColumnEnum>( );

fastSortColumns.add(FastSortOrderColumnEnum.COMPANY_NAME_ASCENDING);
searchExample.setSortBy(fastSortColumns);
searchExample.setSearchView(“hoovers”);
searchExample.setHits(20);
searchExample.createCriteria( ).andSquareFootageEqualTo(3000L);
DefaultSearchResult rs =

searchDAO.searchForDefaultResultViewDocuments(searchExample);

Paging
SearchExample searchExample = new SearchExample( );
List<FastSortOrderColumnEnum> fastSortColumns = new

ArrayList<FastSortOrderColumnEnum>( );

fastSortColumns.add(FastSortOrderColumnEnum.COMPANY_NAME_ASCENDING);
searchExample.setSortBy(fastSortColumns);
searchExample.setSearchView(“hoovers”);
searchExample.setHits(20);
searchExample.createCriteria( ).andSquareFootageEqualTo(3000L) ;
DefaultSearchResult rs =

searchDAO.searchForDefaultResultViewDocuments(searchExample);

//now get the next set of twenty
searchExample.setOffset(20);
rs =searchDAO.searchForDefaultResultViewDocuments( );

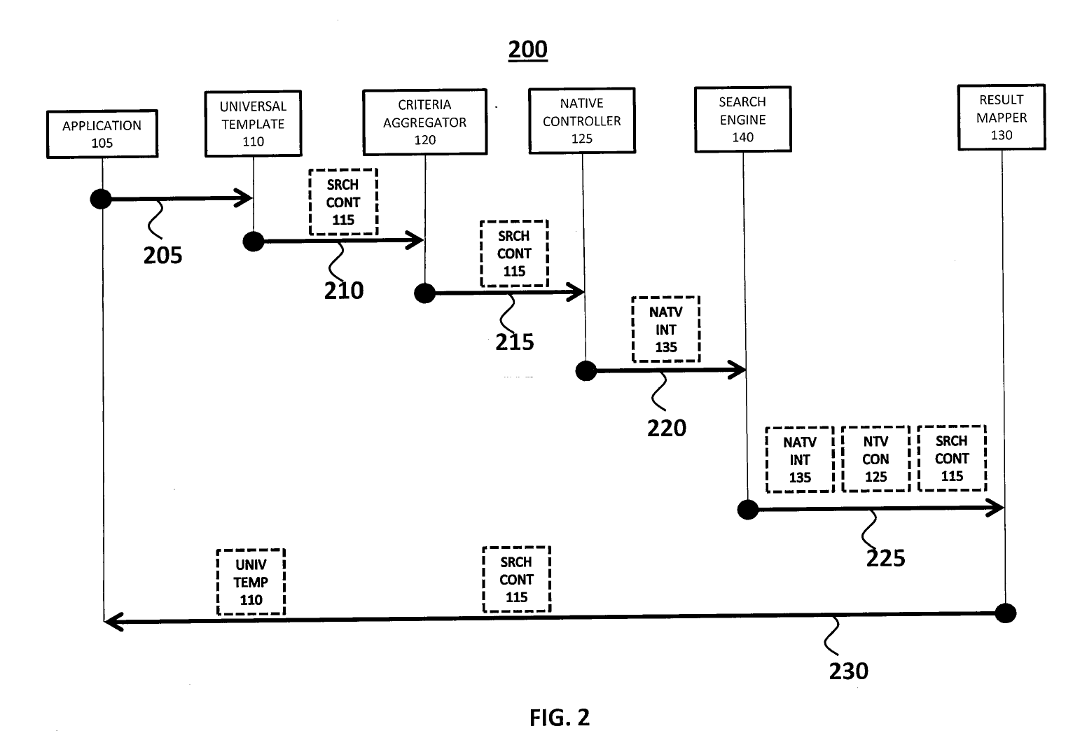

FIG. 2 is a flow diagram of a process 200 in which universal language kit 101 is serving as an interface between application 105 and search engine 140. Process 200 involves the components of system 100, but FIG. 2 uses abbreviations for the names of the components of system 100. Process 200 commences with step 205.

In step 205, application 105 transmits the application criteria sqft and city to universal template 110. Universal template 110 receives the application criteria sqft and city and instantiates or creates a search-example. A search-example is a vehicle that converts application criteria to universal search criteria. That is, by instantiating the search-example for application criteria sqft and city, universal template 110 effectively converts application criteria sqft and city to universal search criteria. Universal search criteria are search criteria having a value and a method or function associated therewith.

For example, universal template 110 associates search methods that may include, but are not limited to the methods listed in the table below:

METHOD TABLE

EqualTo
NotEqualTo
GreaterThan
GreaterOrEqualTo
LessThan
LessThanOrEqualTo
In
NotIn
Between
NotBetween

As mentioned above, universal template 110 receives the application criteria sqft and city and instantiates the search-example. For example, the search-example may be instantiated as a SearchExample object from a SearchExample class as follows:

SearchExample searchExample=new SearchExample( ):

Universal template 110 may also convert application criteria sqft and city to universal search criteria as follows:

searchExample.createCriteria( ).andSquareFootageEqualTo(sqft).
andAddressCityNameEqualTo (city)

According to the example above, the universal search criteria SquareFootage and AddressCityName include the method “EqualTo”.

From step 205, process 200 progresses to step 210.

In step 210, universal template 110 transmits the universal search criteria SquareFootage and AddressCityName to criteria aggregator 120 via search controller 115.

In FIG. 2, search controller 115 is shown in steps of process 200 as a dotted box. The dotted box illustrates a passing of information to search controller 115, and from search controller 115 to a subsequent component. For example, in step 210, universal template 110 transmits the universal search criteria to criteria aggregator 120. In operation, universal template 110 transmits the universal search criteria to search controller 115, search controller 115 receives the universal search criteria, and further transmits the universal search criteria to criteria aggregator 120.

Criteria aggregator 120 receives universal search criteria SquareFootage and NameofCity. Criteria aggregator 120 combines the universal search criteria SquareFootage and NameofCity to create a base search expression. The base search expression combines universal search criteria with operators such as, but not limited to: AND and OR. The AND operator represents a logical conjunction. If the base search expression connects two universal search criteria with the AND operator, a search based on the resultant base expression will only search for both universal search criteria. That is, a true value, i.e., a match to corresponding search data, must be present for both universal search criteria for a result to be returned. The OR operator represents a logical disjunction. If the base expression combines the universal search criteria with an OR operator, then a search will return a true value if either of the universal search criteria is true.

For example, if criteria aggregator 120 combines SquareFootage and NameofCity with the AND operator, a resulting base search expression may be as follows:

(SquareFootage)AND(NameofCity)

If criteria aggregator 120 combines SquareFootage and NameofCity with an OR operator, a resulting base search expression may be as follows:

(SquareFootage)OR(NameofCity)

Criteria aggregator 120 may utilize a weighting system for each universal search criterion. For example, if a particular universal search criterion is of greater importance than another universal search criterion, the particular criterion will be emphasized by criteria aggregator 120 in the resulting base expression. An emphasized universal search criterion will ultimately generate a search result that has a greater amount of data associated with the emphasized universal search criterion, e.g., an amount of data proportional to the weighting system.

From step 210, process 200 progresses to step 215.

In step 215, criteria aggregator 120 transmits the base search expression to native connector 125 via search controller 115. Native connector 125 processes the base search expression resulting in a finished search expression. The finished search expression incorporates the parameters required by search engine 140. From step 215, process 200 progresses to step 220.

In step 220, the finished search expression is transmitted from native connector 125 to search engine 140 via native interface 135. In FIG. 2, native interface 135, similarly to search controller 115, is represented by a dotted box. Native interface 135 is a component that communicates between search engine 140 and native connector 125. In particular, native interface 135 converts the base search expression to a format required by search engine 140. For example, native interface 135 may convert the base search expression to a HTTP request format.

Search engine 140 processes the finished search expression to generate a search result. From step 220, process 200 progresses to step 225.

In step 225, search engine 140 transmits the search result to result mapper 130. The path of communication from search engine 140 to result mapper 130 includes native interface 135, native connector 125 and search controller 115, which are represented by dotted boxes in FIG. 2. Result mapper 130 receives the search result in the native format, processes the search result, and converts the search result to a universal format result. From step 225, process 200 progresses to step 230.

In step 230, result mapper 130 transmits the universal format result to application 105, via search controller 115 and universal template 110, which are represented by dotted boxes in FIG. 2. If necessary, universal template 110 translates the universal format result to a format required by application 105.

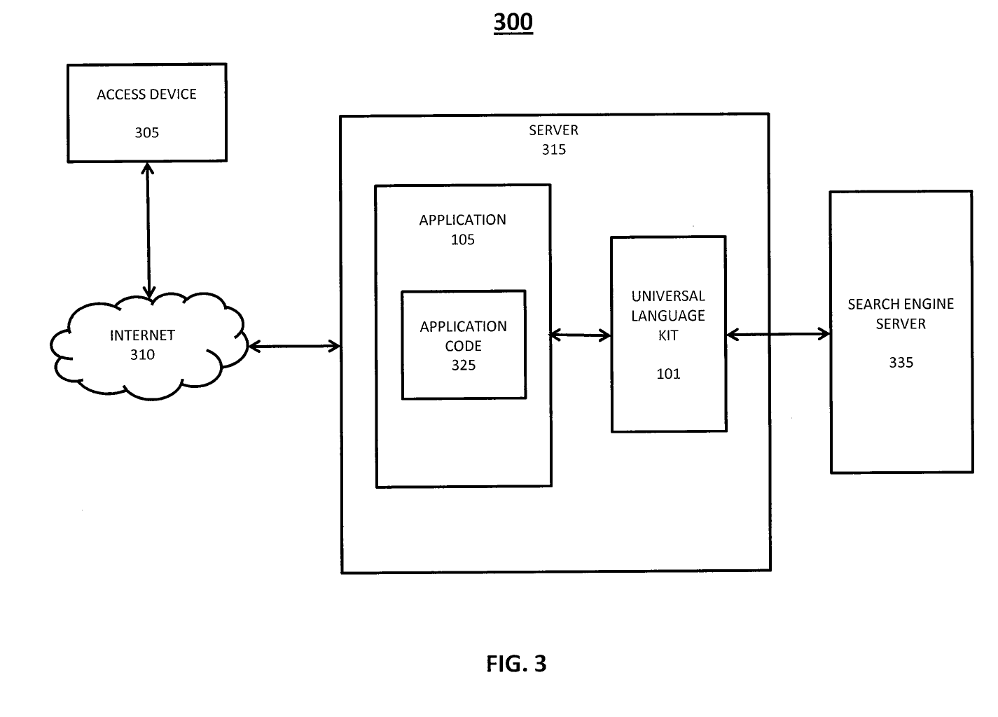

FIG. 3 is a block diagram of a system 300 that includes a server 315 that hosts universal language kit 101. System 300 also includes an access device 305, the Internet 310, and a search engine server 335. Access device 305 and server 315 are communicatively coupled to the Internet 310. Search engine server 335 may be directly coupled to server 315, as shown in FIG. 3, or communicatively coupled via the Internet 310 or another network (not shown). Server 315 includes application 105, which, in turn, includes application code 325.

Access device 305 is an apparatus, for example a personal computer, through which a user of access device 305 can access server 315 via the Internet 310. The user provides to access device 305, inputs that are transmitted via the Internet 310 to server 315. Within server 315, the inputs are received by application 105. Within application 105, application code 325 receives the inputs and converts them into application inputs.

Universal language kit 101 receives the application inputs, converts them into universal search criteria, and transmits the universal search criteria to search engine server 335.

Search engine server 335 includes, or is coupled to, a search engine (not shown in FIG. 3), e.g., search engine 140, that retrieves data according to the universal search criteria. The search engine generates a search result, and search engine server 335 transmits the search result to universal language kit 101.

Universal language kit 101 converts the search result to a universal format result, and provides the universal format result to application code 325.

Application code 325 returns the universal format result to the user. For example, application code 325 may present the universal format result, via server 315 and the Internet 310, on a display of access device 305.

If the search engine on search engine server 335 is modified, exchanged, or otherwise altered, universal language kit 101 is the only component of system 300 that will require a corresponding alteration. Thus, universal language kit 101 insulates application code 325 from search engine server 335 and allows for a compartmentalized communication link between search engine server 335 and application code 325.

Although, in FIG. 3, universal language kit 101 is shown as being a separate component from application 105, universal language kit 101 could be implemented as a component of application 105, for example, in the form of a plug-in module.

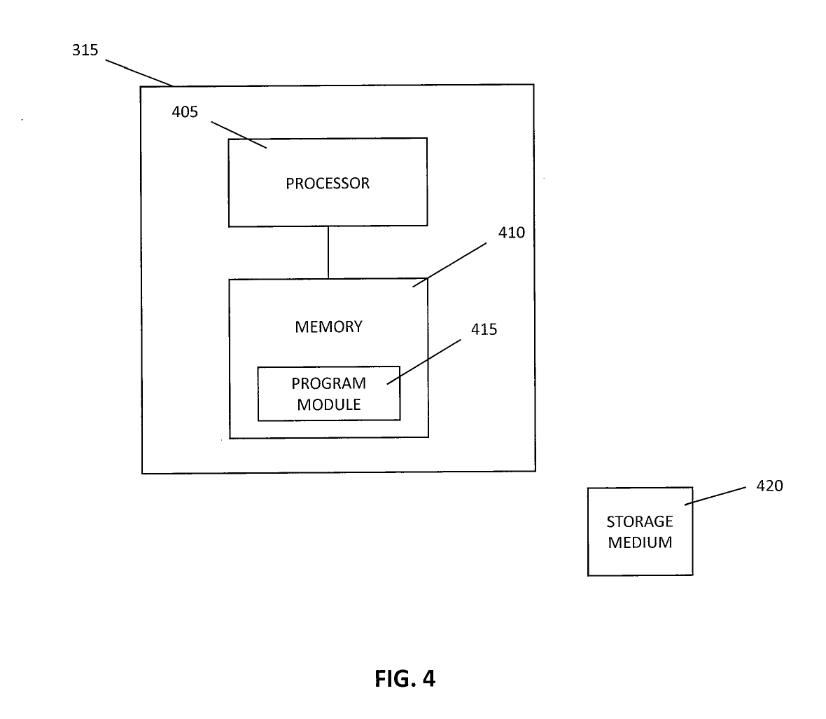

FIG. 4 is a block diagram of a computer implementation of server 315. Although server 315 is represented herein as a standalone device, it is not limited to such, but instead can be coupled to other devices (not shown) in a distributed processing system. Server 315 includes a processor 405, and a memory 410.

Processor 405 is an electronic device configured of logic circuitry that responds to and executes instructions.

Memory 410 is a tangible computer-readable medium encoded with a computer program. In this regard, memory 410 stores data and instructions which are readable and executable by processor 405 for controlling the operation of processor 405. Memory 410 may be implemented in a random access memory (RAM), a hard drive, a read only memory (ROM), or a combination thereof. One of the components of memory 410 is a program module 415.

Program module 415 contains instructions for controlling processor 405 to execute the operations described herein, with reference to FIGS. 1-3, and in particular the operations of universal language kit 101.

For example, under control of program module 415, processor 405 (a) receives application criteria from an application, (b) converts the application criteria into a search expression that is compatible with a search engine, and (c) transmits the search expression to the search engine. Additionally, processor 405 (d) receive a result from the search engine, (e) convert the application criteria into a search expression that is compatible with a search engine, and (f) transmit the reformatted result to the application.

As mentioned above, universal language kit 101 can interface with many search engines. For example, in a case where there is a second search engine, processor 405, under control of program module 415, (a) converts the application criteria into a second search expression that is compatible with the second search engine, and (b) transmits the second search expression to the second search engine.

As is also mentioned above, universal language kit 101 can be invoked from one of the many applications, to interface with one of the many search engines. For example, in a case where there is a second application and a second search engine, processor 405, under control of program module 415, (a) receives second application criteria from the second application, (b) converts the second application criteria into a second search expression that is compatible with the second search engine, and (c) transmits the second search expression to the second search engine.

The term “module” is used herein to denote a functional operation that may be embodied either as a stand-alone component or as an integrated configuration of a plurality of sub-ordinate components. Thus, program module 415 may be implemented as a single module or as a plurality of modules that operate in cooperation with one another. Moreover, although program module 415 is described herein as being installed in memory 410, and therefore being implemented in software, it could be implemented in any of hardware (e.g., electronic circuitry), firmware, software, or a combination thereof.

While program module 415 is indicated as being already loaded into memory 410, it may be configured on a storage medium 420 for subsequent loading into memory 410. Storage medium 420 is also a tangible computer-readable medium encoded with a computer program, and can be any conventional storage medium that stores program module 415 thereon. Examples of storage medium 420 include a floppy disk, a compact disk, a magnetic tape, a read only memory, an optical storage media, universal serial bus (USB) flash drive, a digital versatile disc, or a zip drive. Storage medium 420 can also be a random access memory, or other type of electronic storage, located on a remote storage system and coupled to server 315 via the Internet 310.

While the present disclosure has been described with reference to one or more exemplary embodiments, it will be understood by those skilled in the art that various changes may be made and equivalents may be substituted for elements thereof without departing from the scope of the present disclosure. In addition, many modifications may be made to adapt a particular situation or material to the teachings of the disclosure without departing from the scope thereof. Therefore, it is intended that the present disclosure not be limited to the particular embodiment(s) disclosed.

The terms “comprises” or “comprising” are to be interpreted as specifying the presence of the stated features, integers, steps or components, but not precluding the presence of one or more other features, integers, steps or components or groups thereof. The terms “a” and “an” are indefinite articles, and as such, do not preclude embodiments having pluralities of articles.

What is claimed is:

1. A method comprising:
receiving application criteria from an application;
converting said application criteria into a search expression that is compatible with a search engine; and
transmitting said search expression to said search engine.

2. The method of claim 1, further comprising:
receiving a result from said search engine;
converting said result into a reformatted result that is compatible with said application; and
transmitting said reformatted result to said application.

3. The method of claim 1,
wherein said search expression is a finished search expression, and
wherein said converting comprises:
converting said application criteria to universal search criteria;
combining said universal search criteria to form a base search expression; and
combining said base search expression with a parameter that is required by said search engine, to form said finished search expression.

4. The method of claim 3, wherein said parameter defines how said result from said search engine is to be formatted.

5. The method of claim 1,
wherein said search expression is a first search expression, and said search engine is a first search engine, and
wherein said method further comprises:
converting said application criteria into a second search expression that is compatible with a second search engine; and
transmitting said second search expression to said second search engine.

6. The method of claim 1,
wherein said application is a first application, said application criteria is first application criteria, said search expression is a first search expression, and said search engine is a first search engine, and
wherein said method further comprises:
receiving second application criteria from a second application;
converting said second application criteria into a second search expression that is compatible with a second search engine; and
transmitting said second search expression to said second search engine.

7. A system comprising:
a processor; and
a memory that contains instructions that are readable by said processor, and that cause said processor to:
receive application criteria from an application;
convert said application criteria into a search expression that is compatible with a search engine; and
transmit said search expression to said search engine.

8. The system of claim 7, wherein said instructions further cause said processor to:
receive a result from said search engine;
convert said result into a reformatted result that is compatible with said application; and
transmit said reformatted result to said application.

9. The method of claim 7,
wherein said search expression is a finished search expression, and
wherein said instructions, to cause said processor to convert said application criteria, cause said processor to:
convert said application criteria to universal search criteria;
combine said universal search criteria to form a base search expression; and
combine said base search expression with a parameter that is required by said search engine, to form said finished search expression.

10. The system of claim 9, wherein said parameter defines how said result from said search engine is to be formatted.

11. The system of claim 7,
wherein said search expression is a first search expression, and said search engine is a first search engine, and
wherein said instructions further cause said processor to:
convert said application criteria into a second search expression that is compatible with a second search engine; and
transmit said second search expression to said second search engine.

12. The system of claim 7,
wherein said application is a first application, said application criteria is first application criteria, said search expression is a first search expression, and said search engine is a first search engine, and
wherein said instructions further cause said processor to:
receive second application criteria from a second application;
convert said second application criteria into a second search expression that is compatible with a second search engine; and
transmit said second search expression to said second search engine.

13. A storage medium that is tangible, comprising
instructions that are readable by a processor, and that cause said processor to:
receive application criteria from an application;
convert said application criteria into a search expression that is compatible with a search engine; and
transmit said search expression to said search engine.

14. The storage medium of claim 13, wherein said instructions further cause said processor to:
receive a result from said search engine;
convert said result into a reformatted result that is compatible with said application; and
transmit said reformatted result to said application.

15. The storage medium of claim 13,
wherein said search expression is a finished search expression, and
wherein said instructions, to cause said processor to convert said application criteria, cause said processor to:
convert said application criteria to universal search criteria;
combine said universal search criteria to form a base search expression; and
combine said base search expression with a parameter that is required by said search engine, to form said finished search expression.

16. The storage medium of claim 15, wherein said parameter defines how said result from said search engine is to be formatted.

17. The storage medium of claim 13,
wherein said search expression is a first search expression, and said search engine is a first search engine, and
wherein said instructions further cause said processor to:
convert said application criteria into a second search expression that is compatible with a second search engine; and
transmit said second search expression to said second search engine.

18. The storage medium of claim 13,
wherein said application is a first application, said application criteria is first application criteria, said search expression is a first search expression, and said search engine is a first search engine, and
wherein said instructions further cause said processor to:
receive second application criteria from a second application;
convert said second application criteria into a second search expression that is compatible with a second search engine; and
transmit said second search expression to said second search engine.
